(19) United States
(12) Patent Application Publication
(10) Pub. No.: US 2006/0294149 A1
(43) Pub. Date: Dec. 28, 2006

(54) Method and apparatus for supporting memory hotplug operations using a dedicated processor core

(75) Inventors: Harinarayanan Seshadri, Bangalore (IN); Steven R. Carbonari, Beaverton, OR (US)

Correspondence Address: LAWRENCE CHO;C/O PORTFOLIOIP, P. O. BOX 52050, MINNEAPOLIS, MN, 55402, US

(73) Assignee: Intel Corporation

(21) Appl. No.: 11/166,880

(22) Filed: Jun. 24, 2005

(51) Int. Cl. G06F 17/30

(52) U.S. Cl. 707/200

(57) ABSTRACT

A method for performing system management includes utilizing a dedicated processor core to perform a system management task. Other embodiments are described and claimed.

### TECHNICAL FIELD

Embodiments of the present invention pertain to basic input output systems (BIOS). More specifically, embodiments of the present invention relate to a method and apparatus for supporting memory hotplug operations using a dedicated processor core.

### BACKGROUND

Memory has become more reliable due to better manufacturing processes and memory protection technologies such as error correction codes (ECC). Hot pluggable memory systems have also been made available which allow for memory to meet reliability, availability, and serviceability (RAS) goals. Hot pluggable memory systems allow memory to be added or replaced without taking a computer system off-line. This is ideal for computer systems running memory intensive and mission critical applications for databases, enterprise resource planning, customer relationship management, web serving, e-commerce, and other applications.

In order to add or replace memory in a hot pluggable memory system, procedures such as memory initialization and calibration need to be performed prior to making the new memory available. These procedures typically generated a system wide mask of all interrupts in the computer system which resulted in a long operating system stall which would occasionally crash the system. One approach used in the past to reduce the long operating system stall was to utilize a number of BIOS interrupts to perform the necessary procedures gradually over time. Utilizing a number of BIOS interrupts reduced the long operating system stall, but this solution still required that the operating system be interrupted and stalled periodically for milliseconds at a time which adversely affected performance. Computer systems configuring a memory that was 4 gigabytes in size, for example, would experience operating system interruptions and stalls for over a day, which was undesirable.

### BRIEF DESCRIPTION OF THE DRAWINGS

The features and advantages of embodiments of the present invention are illustrated by way of example and are not intended to limit the scope of the embodiments of the present invention to the particular embodiments shown.

FIG. 1 is a block diagram of a first embodiment of a computer system in which an example embodiment of the present invention resides.

FIG. 2 is a block diagram of a second embodiment of a computer system in which an example embodiment of the present invention resides.

FIG. 3 is a block diagram of a basic input output system used by a computer system according to an example embodiment of the present invention.

FIGS. 4 is a block diagram of a system management module according to an example embodiment of the present invention.

FIGS. 5a and 5b are state diagrams that illustrate core state transitions according to example embodiments of the present invention.

FIG. 6 is a flow chart illustrating a method for performing system management according to an example embodiment of the present invention.

### DETAILED DESCRIPTION

In the following description, for purposes of explanation, specific nomenclature is set forth to provide a thorough understanding of embodiments of the present invention. However, it will be apparent to one skilled in the art that these specific details may not be required to practice the embodiments of the present invention. In other instances, well-known circuits, devices, and programs are shown in block diagram form to avoid obscuring embodiments of the present invention unnecessarily.

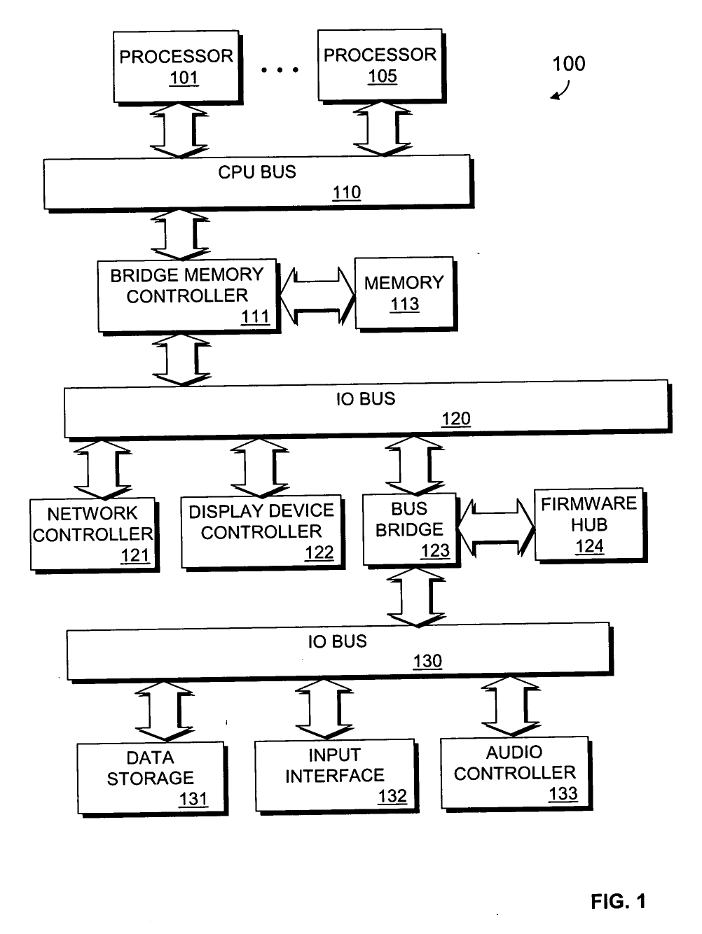

FIG. 1 is a block diagram of a first embodiment of a computer system 100 in which an embodiment of the present invention resides. The computer system 100 includes one or more processors that process data signals. As shown, the computer system 100 includes a first processor 101 and an nth processor 105, where n may be any number. The processors 101 and 105 may be complex instruction set computer microprocessors, reduced instruction set computing microprocessors, very long instruction word microprocessors, processors implementing a combination of instruction sets, or other processor devices. The processors 101 and 105 may be multi-core processors with multiple processor cores on each chip. The processors 101 and 105 are coupled to a CPU bus 110 that transmits data signals between processors 101 and 105 and other components in the computer system 100.

The computer system 100 includes a memory 113. The memory 113 includes a main memory that may be a dynamic random access memory (DRAM) device. The memory 113 may store instructions and code represented by data signals that may be executed by the processors 101 and 105. A cache memory (processor cache) may reside inside each of the processors 101 and 105 to store data signals from memory 113. The cache may speed up memory accesses by the processors 101 and 105 by taking advantage of its locality of access. In an alternate embodiment of the computer system 100, the cache may reside external to the processors 101 and 105.

A bridge memory controller 111 is coupled to the CPU bus 110 and the memory 1 13. The bridge memory controller 111 directs data signals between the processors 101 and 105, the memory 113, and other components in the computer system 100 and bridges the data signals between the CPU bus 110, the memory 113, and a first input output (IO) bus 120.

The first IO bus 120 may be a single bus or a combination of multiple buses. The first IO bus 120 provides communication links between components in the computer system 100. A network controller 121 is coupled to the first IO bus 120. The network controller 121 may link the computer system 100 to a network of computers (not shown) and supports communication among the machines. A display device controller 122 is coupled to the first IO bus 120. The display device controller 122 allows coupling of a display device (not shown) to the computer system 100 and acts as an interface between the display device and the computer system 100.

A second IO bus 130 may be a single bus or a combination of multiple buses. The second IO bus 130 provides communication links between components in the computer system 100. A data storage device 131 is coupled to the second IO bus 130. The data storage device 131 may be a hard disk drive, a floppy disk drive, a CD-ROM device, a flash memory device or other mass storage device. An input interface 132 is coupled to the second IO bus 130. The input interface 132 may be, for example, a keyboard and/or mouse controller or other input interface. The input interface 132 may be a dedicated device or can reside in another device such as a bus controller or other controller. The input interface 132 allows coupling of an input device to the computer system 100 and transmits data signals from an input device to the computer system 100. An audio controller 133 is coupled to the second IO bus 130. The audio controller 133 operates to coordinate the recording and playing of sounds.

A bus bridge 123 couples the first IO bus 120 to the second IO bus 130. The bus bridge 123 operates to buffer and bridge data signals between the first IO bus 120 and the second IO bus 130. A firmware hub 124 is coupled to the bus bridge 123. According to one embodiment, the firmware hub 124 includes a non-volatile memory such as read only memory. The non-volatile memory stores important instructions and code represented by data signals that may be executed by the processor 101 and/or processor 105. The computer system basic input output system (BIOS) may be stored on the non-volatile memory.

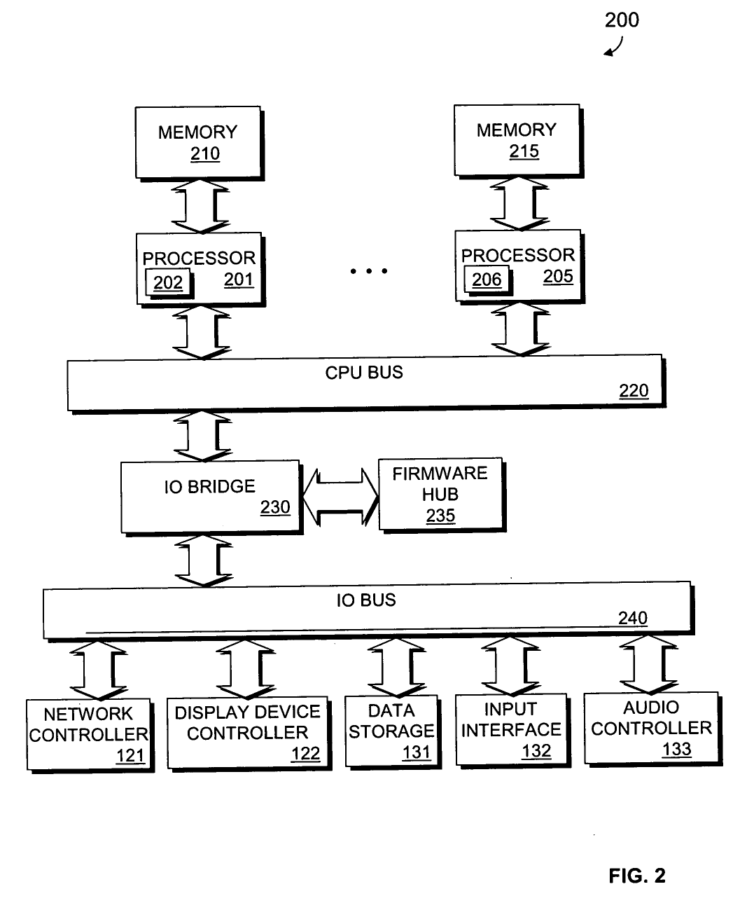

FIG. 2 illustrates a block diagram of a second embodiment of a computer system 200 in which an example embodiment of the present invention resides. The computer system 200 includes components which are similar to those described with reference to FIG. 1. The computer system 200 includes one or more processors that process data signals. As shown, the computer system 200 includes a first processor 201 and an nth processor 205, where n may be any number. The processors 201 and 205 may be complex instruction set computer microprocessors, reduced instruction set computing microprocessors, very long instruction word microprocessors, processors implementing a combination of instruction sets, or other processor devices. The processors 201 and 205 may be multi-core processors with multiple processor cores on each chip.

According to an embodiment of the computer system 200, the processors 201 and 205 each include memory controllers 202 and 206, respectively. The memory controllers 202 and 206 allow processors 201 and 205 to interface directly with and utilize memory 210 and 215 respectively. The memory 210 and 215 may each include a main memory that may be a dynamic random access memory (DRAM) device. The memory 210 and 215 may store instructions and code represented by data signals that may be executed by the processors 210 and 215.

The processors 201 and 205 are coupled to a CPU bus 220 that transmits data signals between processors 201 and 205 and other components in the computer system 200.

An IO bridge 230 is coupled to the CPU bus 220. The IO bridge 230 directs data signals between the processors 201 and 205, and other components in the computer system 200 and bridges the data signals between the CPU bus 220 and an input output bus 240. Although a single IO bus 240 is shown in FIG. 2, it should be appreciated that the IO bridge 230 may include a plurality of IO slots to allow interfacing with a plurality of IO buses.

A firmware hub 235 is coupled to the IO bridge 230. According to an embodiment of the computer system 200, the firmware hub 235 includes a non-volatile memory such as read only memory. The non-volatile memory stores important instructions and code represented by data signals that may be executed by the processors 201 and/or 205. The computer system BIOS may be stored on the non-volatile memory. According to an alternate embodiment of the computer system 200, the firmware hub 235 may be connected to a bridge controller connected to the IO bus 240.

The IO bus 240 may be a single bus or a combination of multiple buses. The IO bus 240 provides communication links between components in the computer system 200. The components may include a network controller 121, a display device controller 122, a data storage device 131, an input interface 132, an audio controller 133, and/or other devices.

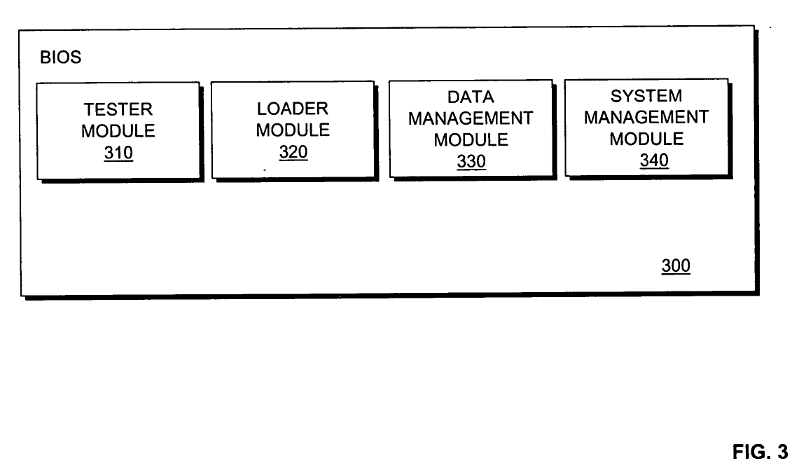

FIG. 3 is a block diagram of a BIOS 300 used by a computer system according to an embodiment of the present invention. The BIOS 300 may be used to implement the BIOS stored in a firmware hub such as the one shown as 124 in FIG. 1 or 235 shown in FIG. 2 for example. The BIOS 300 includes programs that may be run when a computer system is booted up and programs that may be run in response to triggering events. The BIOS 300 may include a tester module 310. The tester module 310 performs a power-on self test (POST) to determine whether the components on the computer system are operational.

The BIOS 300 may include a loader module 320. The loader module 320 locates and loads programs and files to be executed by a processor on the computer system. The programs and files may include, for example, boot programs, system files (e.g. initial system file, system configuration file, etc.), and the operating system.

The BIOS 300 may include a data management module 330. The data management module 330 manages data flow between the operating system and components on the computer system. The data management module 330 may operate as an intermediary between the operating system and components on the computer system and operate to direct data to be transmitted directly between components on the computer system.

The BIOS 300 includes a system management module 340. The system management module 340 detects the occurrence of a system management event. The system management event may be, for example, a memory hotplug operation or other system management event that may require extensive firmware operations. The system management module 340 identifies a dedicated core and directs the dedicated core to perform a system management task to handle the system management event. The dedicated processor may be identified in response to a processor core pre-allocation during POST. Alternatively, the dedicated processor may be identified dynamically utilizing predefined criteria if an operating system supports CPU on/off-line. According to an embodiment of the BIOS 300, when the system management event is a memory hotplug operation, the system management module 350 may direct the dedicated core to support the system management task of initializing and configuring the memory and/or re-silvering the memory.

It should be appreciated that the BIOS 300 may include additional modules to perform other tasks. The tester module 310, loader module 320, data management module 330, and system management module 340 may be implemented using any appropriate procedure or technique.

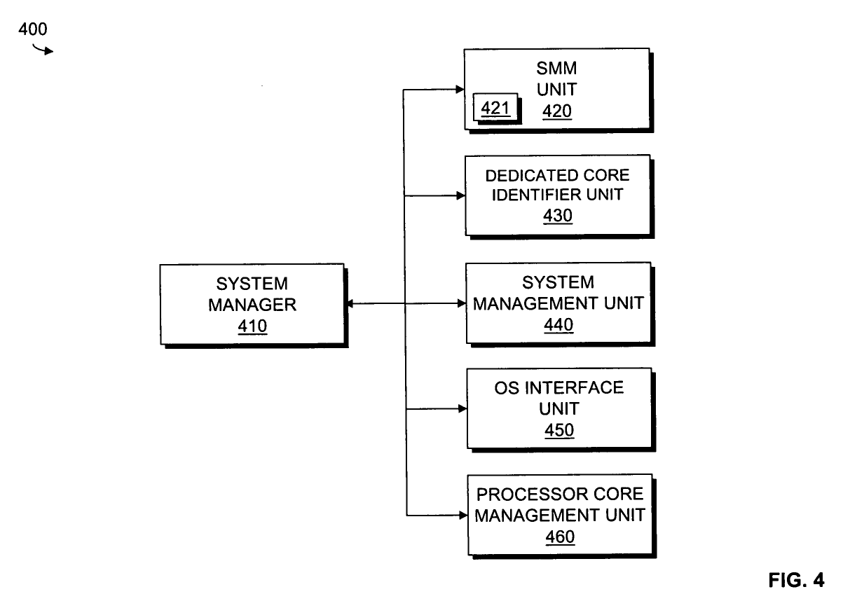

FIG. 4 is a block diagram of a system management module 400 according to an embodiment of the present invention. The system management module 400 may be implemented as the system management module 340 shown in FIG. 3. The system management module 400 includes a system manager 410. The system manager 410 interfaces with and transmits information between other components in the system management module 400.

The system management module 400 includes a system management mode (SMM) unit 420. According to an embodiment of the present invention, when a memory controller identifies various events or timeouts, such as a system management event, a system management interrupt (SMI) is asserted which puts a processor into system management mode. In system management mode, the system management mode unit 420 saves the state of the processor(s) and redirects all memory cycles to a protected area of main memory reserved for system management mode.

The system management mode unit 420 includes an SMI handler 421. The SMI handler 421 determines the cause of the SMI and operates to resolve the problem. According to an embodiment of the system management module 400, the SMI handler 421 determines whether an operating system of a computer system supports CPU on/off-line. The SMI handler 421 may make this determination using either a static procedure or a dynamic procedure. According to one embodiment, the static procedure implements a BIOS setup option which prompts a user to input the functionality of the operating system. According to one embodiment, the dynamic procedure involves having the SMI handler 421 detect an operating system capabilities (OSC) call and determining whether a bit has been set by an operating system power management (OSPM) device driver. Afterwards, the SMI handler 421 may also program a flash area or a processor cache to be a reset vector for a processor core that will perform a system management task to handle system management event.

According to an embodiment of the system management mode unit 420, when the SMI handler 421 determines that the operating system of the computer system supports CPU offline/online, it initiates a CPU off-line request in response to system management event such as a memory hotplug. The SMI handler 421 records the system management event in a scratch register and generates a notification to the operating system. According to one embodiment, the SMI handler 421 generates an system configuration interrupt (SCI) to notify an appropriate Advanced Configuration and Power Interface (ACPI) (published 1996) object requesting a dedicated processor core to be off-lined.

The system management module 400 includes a dedicated core identifier unit 430. The dedicated core identifier unit 430 identifies a dedicated processor core for performing the system management task to handle the system management event. According to an embodiment of the system management module 400, for operating systems that do not support CPU off-line/online, a processor core that has been pre-allocated during POST may be identified by the dedicated core identifier unit 430 for performing the system management task. The processor core identified is not reported to the operating system and will not be allocated for by the operating system for use. According to an embodiment of the system management module 400, for operating systems that support CPU off-line/online, a processor core may be identified by the dedicated core identifier unit 430 for performing the system management task based on a location of where the system management event originated. For example, if the system management event is a memory hotplug and a memory controller for the new memory resides in a processor, a processor core in the processor may be identified. If the system management event is a memory hotplug and a memory controller for the new memory resides outside a processor, a processor core used as the processor core for booting the computer system may be identified. The processor core selected for booting a computer system may be a processor core having a lowest processor identifier.

The system management module 400 includes a system management unit 440. The system management unit 440 directs the dedicated processor core to perform the system management task to handle the system management event. According to an embodiment of the system management module 400, when the system management event is a memory hotplug, the system management unit 440 directs the dedicated processor core to initialize and calibrate the memory. This may involve using a side band channel to configure the memory and perform speed testing. For memory systems that support redundant array of independent disks (RAID) configurations, the system management unit 440 may direct the dedicated processor core to re-silver the new memory. It should be appreciated that the system management unit 440 may be implemented by the flash area or processor cache programmed by the SMI handler 421.

The system management module 400 includes an operating system (OS) interface unit 450. The operating system interface unit 450 may notify the operating system that the new memory is available for application use. The operating system interface unit 450 may communicate with the operating system via a SCI. According to an embodiment of the present invention, SCIs may be used by a BIOS to signal to an operating system that a configuration operation is requested.

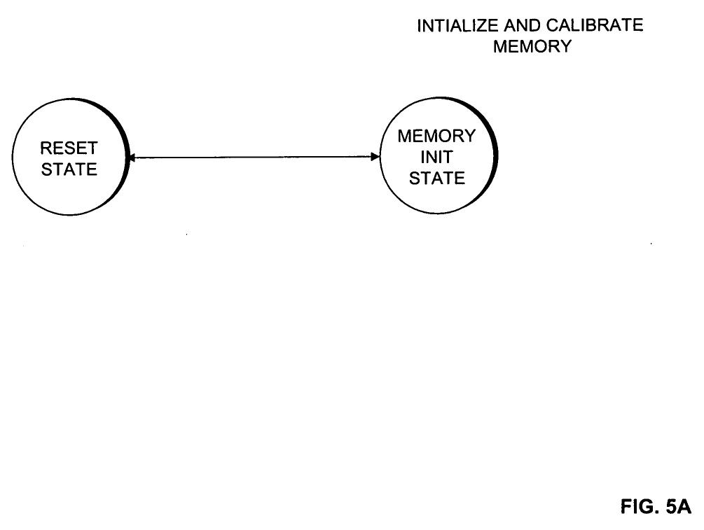

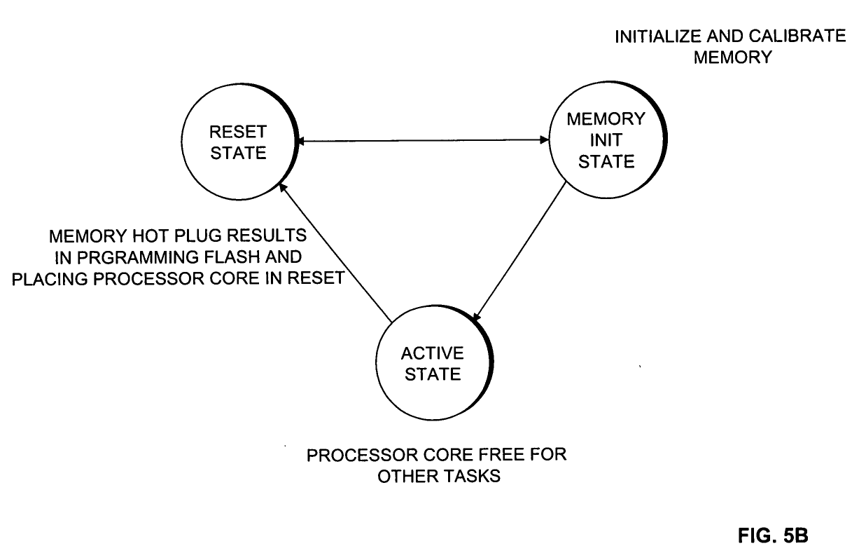

The system management module 400 includes a processor core management unit 460. The processor core management unit 460 manages the states of the dedicated processor core. According to an embodiment of the system management module 400, if an operating system does not support CPU on/off-line, the dedicated processor core may be placed in a memory initialization state or a reset state by the processor core management unit 460. For example, after the SMI handler 421 programs the flash area or processor cache to be the reset vector for the dedicated processor core, the processor core management unit 460 may release the processor core from reset state to memory initialization state. After the system management unit 440 directs the dedicated processor core to perform the system management task, the processor core management unit 460 may put the dedicated processor core back to reset state. The processor core state transition for a memory hotplug operation in a computer system with an operating system that does not support CPU on/off-line is shown in FIG. 5A.

If an operating system supports CPU on/off-line, the dedicated processor core may be placed in an active state, reset state, or a memory initialization state by the processor core management unit 460. For example, after receiving a confirmation from an operating system that the dedicated processor core has been off-lined (i.e. receiving an eject request) and confirming the system management event from the scratch register, the processor core management unit 460 places the dedicated processor core in a reset state. After the SMI handler 421 programs the flash area or processor cache to be the reset vector for the dedicated processor core, the processor core management unit 460 may release the processor core from reset state to the memory initialization state. After the system management unit 440 directs the dedicated processor core to perform the system management task, the processor core management unit 460 may put the dedicated processor core back to active state. The processor core state transition for a memory hotplug operation in a computer system with an operation system that supports CPU on/off-line is shown in FIG. 5B.

It should be appreciated that the system manager 410, system management mode unit 420, dedicated core identifier unit 430, system management unit 440, operating system interface unit 450, and processor core management unit 460 may be implemented using any appropriate procedure or technique. Although the system management module 400 has been described with reference to operating with a system management mode unit 420 having a SMI handler 421, it should be appreciated that the system management module 400 may also operate in response to processor management interrupts or other types of interrupts.

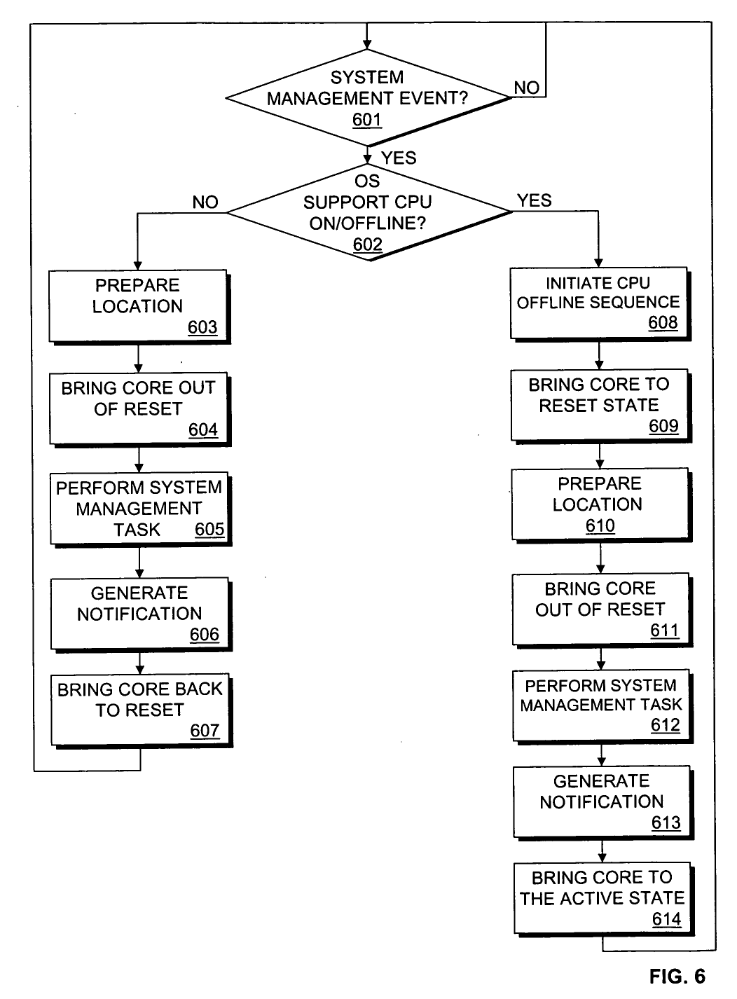

FIG. 6 is a flow chart illustrating a method for performing system management according to an example embodiment of the present invention. At 601, it is determined whether a system management event has occurred. According to an embodiment of the present invention, a system management event may be determined by detecting SMI interrupts. In one embodiment, occurrences of specific system management events, such as memory hotplug operations, may be of interest. In this embodiment, SMI interrupts associated with memory hotplug operations are detected. If a system management event has occurred, control proceeds to 602. If a system management event has not occurred, control returns to 601.

At 602, it is determined whether operating system support for CPU on/off-line is available. According to an embodiment of the present invention, determining whether operating system support for CPU on/off-line is available may be achieved by accessing information provided in a BIOS setup option in which the functionality of the operating system is inputted. Alternatively, determining whether operating system support for CPU on/off-line is available may be achieved dynamically by detecting an OSC call and determining whether a bit has been set by an operating system power management OSPM device driver. The OSC call may be a ACPI OSC method. If operating system support for CPU on/off-line is not available, control proceeds to 603. If operating system support for CPU on/off-line is available, control proceeds to 608.

According to an embodiment of the present invention, for operating systems that do not support CPU on/off-lining, a processor core is pre-allocated during POST for being a dedicated processor core for performing system management tasks to handle system management events. For operating systems that do support CPU on/off-lining, a processor core is selected by an SMI handler to be the dedicated processor core.

At 603, a location is prepared to allow a system management task to be performed to handle the system management event. According to an embodiment of the present invention, the location is programmed to be the reset vector for the dedicated processor core. According to an embodiment of the present invention, the location may be a flash area. The location may alternatively be a processor cache in a computer system that supports cache as RAM.

At 604, the dedicated processor core is brought out of a reset state.

At 605, the dedicated processor core performs the system management task. According to an embodiment of the present invention where the system management event is a memory hotplug operation, the system management task may involve initializing and calibrating the new memory. The system management task may also involve re-silvering the new memory.

At 606, a notification that the system management task has been completed may be generated. According to an embodiment of the present invention when the system management event is a memory hotplug operation, a notification that a new memory is available may be provided to the operating system.

At 607, the dedicated core is brought back to the reset state. Control returns to 601.

At 608, a CPU off-line sequence is initiated. According to an embodiment of the present invention, the type of the system management event is recorded in a scratch register and a request to put the dedicated processor core off-line is made to an appropriate ACPI object in the operating system.

At 609, the dedicated processor core is brought to the reset state. According to an embodiment of the present invention, the dedicated processor core is brought to the reset state from an active state in response to receiving a notification from the operating system that the dedicated processor has been off-lined by the operating system.

At 610, a location is prepared to allow a system management task to be performed to handle the system management event. According to an embodiment of the present invention, the location is programmed to be the reset vector for the dedicated processor core upon confirming that the system management task is appropriate for the type of system management event from the scratch register. For example, upon confirming that the CPU off-line sequence was initiated in response to a memory hotplug operation, an appropriate system management task is programmed. The location may be, for example, a flash area or a processor cache.

At 611, the dedicated processor core is brought out of a reset state.

At 612, the dedicated processor core performs the system management task. According to an embodiment of the present invention where the system management event is a memory hotplug operation, the system management task may involve initializing and calibrating the new memory. The system management task may also involve re-silvering the new memory.

At 613, a notification that the system management task has been completed may be generated. According to an embodiment of the present invention when the system management event is a memory hotplug operation, a notification that a new memory is available may be provided to the operating system.

At 614, the dedicated core is brought back to the active state. Control returns to 601.

FIG. 6 is a flow chart illustrating an embodiment of the present invention. Some of the procedures illustrated in the figures may be performed sequentially, in parallel or in an order other than that which is described. It should be appreciated that not all of the procedures described are required, that additional procedures may be added, and that some of the illustrated procedures may be substituted with other procedures.

Embodiments of the present invention may be provided as a computer program product, or software, that may include an article of manufacture on a machine accessible or machine readable medium having instructions. The instructions on the machine accessible or machine readable medium may be used to program a computer system or other electronic device. The machine-readable medium may include, but is not limited to, floppy diskettes, optical disks, CD-ROMs, and magneto-optical disks or other type of media/machine-readable medium suitable for storing or transmitting electronic instructions. The techniques described herein are not limited to any particular software configuration. They may find applicability in any computing or processing environment. The terms “machine accessible medium” or “machine readable medium” used herein shall include any medium that is capable of storing, encoding, or transmitting a sequence of instructions for execution by the machine and that cause the machine to perform any one of the methods described herein. Furthermore, it is common in the art to speak of software, in one form or another (e.g., program, procedure, process, application, module, unit, logic, and so on) as taking an action or causing a result. Such expressions are merely a shorthand way of stating that the execution of the software by a processing system causes the processor to perform an action to produce a result.

In the foregoing specification, the embodiments of the present invention have been described with reference to specific exemplary embodiments thereof. It will, however, be evident that various modifications and changes may be made thereto without departing from the broader scope of the embodiments of the present invention. The specification and drawings are, accordingly, to be regarded in an illustrative rather than restrictive sense.

What is claimed is:

1. A method for performing system management, comprising:
utilizing a dedicated processor core to perform a system management task.

2. The method of claim 1, further comprising identifying the dedicated processor core from a processor core pre-allocation during a power-on self test.

3. The method of claim 1, further comprising identifying the dedicated processor core based on a location originating a system management event.

4. The method of claim 1, further comprising identifying the dedicated processor core based upon a processor core identifier.

5. The method of claim 1, wherein the system management task comprises supporting a memory hotplug operation.

6. The method of claim 1, wherein utilizing the dedicated processor core to perform the system management task comprises initializing and configuring a memory.

7. The method of claim 6, further comprising re-silvering the memory.

8. The method of claim 6, further comprising notifying an operating system about the availability of the memory.

9. The method of claim 1, wherein the system management tasks are performed upon confirming from a scratch register that a processor off-line sequence is requested in response to a memory hotplug operation.

10. An article of manufacture comprising a machine accessible medium including sequences of instructions, the sequences of instructions including instructions which when executed cause the machine to perform:
utilizing a dedicated processor core to perform a system management task.

11. The article of manufacture of claim 10, further comprising instructions which when executed cause the machine to perform identifying the dedicated processor core from a processor core pre-allocation during a power-on self test.

12. The article of manufacture of claim 10, further comprising instructions which when executed cause the machine to perform identifying the dedicated processor core based on a location originating a system management event.

13. The article of manufacture of claim 10, further comprising instructions which when executed cause the machine to perform identifying the dedicated processor core based upon a processor core identifier.

14. The article of manufacture of claim 10, wherein the system management task comprises supporting a memory hot plug operation.

15. The article of manufacture of claim 10, wherein utilizing the dedicated processor core to perform the system management task comprises initializing and configuring a memory.

16. The article of manufacture of claim 10, wherein the system management tasks are performed upon confirming from a scratch register that a processor off-line sequence is requested in response to a memory hot plug operation.

17. A computer system, comprising:
a processor having multiple processor cores;
a memory; and
a system management module to utilize a dedicated processor core to perform a system management task to handle a system management event.

18. The computer system of claim 17, wherein the system management module includes a system management mode unit to detect the system management event from a system management interrupt.

19. The computer system of claim 17, wherein the system management module includes a dedicated core identifier unit to identify the dedicated processor core based on whether an operating system supports CPU on/off-lining.

20. The computer system of claim 17, wherein the system management event comprises a memory hotplug operation.
